(19) United States
(12) Patent Application Publication
(10) Pub. No.: US 2002/0119332 A1
(43) Pub. Date: Aug. 29, 2002

(54) Alignment and packaging methods and apparatus for optoelectronic, micro-electro mechanical systems, and optical devices

(76) Inventors: Navrit Singh, Fremont, CA (US); Calvin Woon, Palo Alto, CA (US); Rajinder Dhindsa, San Jose, CA (US)

Correspondence Address: LARRY WILLIAMS, 122 CALISTOGA ROAD, PMB-301, SANTA ROSA, CA, 95409-3702, US

(21) Appl. No.: 09/978,171

(22) Filed: Oct. 15, 2001

Related U.S. Application Data
(60) Provisional application No. 60/240,279, filed on Oct. 13, 2000.

(51) Int. Cl. G02F 1/00; G02F 2/00; H01S 3/00; H04B 10/00; H04J 14/00; B32B 15/04

(52) U.S. Cl. 428/457; 359/109

(57) ABSTRACT

Precise positioning of components on support structures is achieved through modifications of properties of the support structure. Improved optoelectronic devices and optoelectronic packages are presented. In addition, improved methods and apparatus are presented for applications such as fabrication, repair, and alignment optimization of optoelectronic packages and optical devices.

### CROSS-REFERENCES

The present application claims priority from U.S. Provisional Patent Application serial No. 60/240279 filed on Oct. 13, 2000. U.S. Provisional Patent Application serial No. 60/240279 filed on Oct. 13, 2000 is hereby incorporated by this reference in its entirety.

### BACKGROUND

This invention relates to improved methods and apparatus for aligning and fabricating components and systems for applications such as optical devices, optoelectronic devices, and micro-electro mechanical systems.

Because of technological advancements and society's continuing need for improved communications and information transfer systems, there has been an ever-increasing demand for wider bandwidth. One of the most commonly recognized practical solutions for meeting this demand is optical communication systems such as those involving optical fibers for transmitting optical signals. However, standard techniques for fabricating, aligning, and integrating optical packages needed for optical communication systems are inefficient, slow, and expensive. These drawbacks can hinder the implementation of wider bandwidth systems.

Optical systems include optical fibers, optical packages, and optoelectronic devices. Optoelectronic or photonic devices are still in their embryonic development stage. These devices use photons instead of electrons to perform processes such as numerical calculations. Photonic devices may one day replace the electronic-base devices such as micro-chips or microprocessors inside computers. The components along with all input and output devices attached to such photonic devices require extraordinary alignment precision, because characteristic dimensions are now of the order of nanometers (10⁻⁹ m) instead of micrometers (10⁻⁶ m)

Typical optical packages have optical components arranged to accommodate input/output optical fibers. The components and fibers must be optically aligned and anchored to maximize the performance and durability of the optical package and the optical communication system. Most optical packages are manufactured either manually or semi-automatically. However, fully automated fabrication equipment and processes are desirable for high production environments so as to reduce the fabrication costs of optical packages and optical systems.

Another area where there is a need for precision alignment is Micro-Electro Mechanical Systems (MEMS). As the supporting technologies to manufacture smaller and smaller MEMS devices matures, the need to develop processes for high precision alignment and attachment to and from and between MEMS devices becomes more critical.

Major time consuming processes in fabricating optical packages involve the precise optical alignment steps and the steps of anchoring the optical components. Standard processes use mechanical and piezoelectric devices and stages for the alignment procedure. These processes provide limited light coupling efficiency and have low productivity due to excessive assembly cycle times.

The typical process includes a passive alignment and an active alignment. Passive alignment is an initial step of the alignment process and provides fast positioning that usually gives about 10-50% light coupling efficiency. This is generally done by using fiducials on the components as alignment points, and this is typically done without a light feedback signal. In most semi-automated systems, the fiducials are recognized using a vision recognition system. Motion stages serve to transport the components to the targeted position for the alignment. With this method, physical-positioning accuracy is limited to a range of about 1-2 micrometers.

Active alignment is used to further improve the alignment for increased light coupling. Active alignment methods use a feedback signal from an input light source during positioning. Piezo-electric stages are typically used as a transport mechanism to provide sub-micron motion along any axis.

Active and passive alignment according to the standard technologies often take more than about 15 minutes to complete the alignment and assembly process for an optical package. Even after such efforts, the alignment efficiency is rarely greater than about 80% using standard alignment technologies.

Components that make up optical packages need precise alignment during the assembly process to achieve the maximum light coupling. In fact, this is essential for meeting the demand for bandwidth. However, the standard technologies appear to be incapable of meeting the demands.

Clearly, there are numerous situations requiring reliable and efficient methods and apparatus for fabricating, aligning, and repairing optoelectronic packages. Furthermore, because of the reduced form factor, (i.e., characteristic dimensions) the tolerances for alignment are tighter. Unfortunately, the typical methods and apparatus have characteristics that may be unsuitable for meeting the requirements for higher bandwidth. There is a need for improved alignment accuracy and improved manufacturability for optoelectronic packages. There is also a need for improved optical packages so that they are more reliable and more economical. Furthermore, there is a need for improved methods for manufacturing optical packages.

### SUMMARY

This invention pertains to methods for accurate and precise positioning of objects, products that are obtainable through use of those methods, and apparatus for carrying out the methods.

An aspect of the invention includes methods of positioning components on a support structure. The method comprises the step of causing position changes by modifying at least a portion of the material of the support structure by inducing at least one of a dimension change, a density change, and an internal stress change.

Examples of methods that may be suitable for modifying the material of the support structure may include one or more steps such as changing the crystal structure, changing the microstructure, changing the ratio of crystalline to non-crystalline material, changing the chemical composition, changing the chemical composition profile, changing the phase, adding material, and removing material.

Another aspect of this invention is a method of providing a substantially permanently stable coupling arrangement using a systematic feedback adjustment. The method is capable of achieving fine resolution and short processing time. This system can be custom-designed for different ranges of adjustments based on the needs of specific components. One embodiment of the invention may be capable of aligning components an order of magnitude faster than currently available methods and with nano-scale precision.

The new coupling arrangement is expected to be capable of performing coarse or fine adjustments independently so as to achieve optimal coupling. The types of adjustments will be determined by the product requirements.

Embodiments of the present invention include optoelectronic devices, apparatus for optoelectronic applications, and methods and apparatus for manufacturing, repairing, and optimizing items such as optical devices, optoelectronic devices, MEMS, and optoelectronic device packages.

It is to be understood that the invention is not limited in its application to the details of construction and to the arrangements of the components set forth in the following description or illustrated in the drawings. The invention is capable of other embodiments and of being practiced and carried out in various ways. In addition, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out aspects of the present invention. It is important, therefore, that the claims be regarded as including such equivalent constructions insofar as they do not depart from the spirit and scope of the present invention.

Further, the purpose of the foregoing abstract is to aid the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is the abstract intended, in any way, to be limiting as to the scope of the invention.

The above and still further features and advantages of the present invention will become apparent upon consideration of the following detailed descriptions of specific embodiments thereof, especially when taken in conjunction with the accompanying drawings.

### DESCRIPTION OF THE DRAWINGS

FIG. 1 is a diagram of an embodiment of the present invention.

FIG. 2 is a diagram of an embodiment of the present invention.

FIG. 3 is a diagram of an embodiment of the present invention.

FIG. 4 is a diagram of an embodiment of the present invention.

FIG. 5 is a diagram of an embodiment of the present invention.

FIG. 6 is a diagram of an embodiment of the present invention.

FIG. 7 is a diagram of an embodiment of the present invention.

FIG. 8 is a diagram of an embodiment of the present invention.

### DESCRIPTION

The following detailed description is primarily related to optical and optoelectronic applications involving a light source such as a solid-state laser as one optical component and a second optical component such as an optical fiber. It is to be understood that aspects of the present invention are not restricted to the following example descriptions. Furthermore, it is to be understood that the methods and apparatus described herein are not restricted to applications involving optics and optoelectronics. The disclosed methods and apparatus can be used in numerous applications requiring precision positioning of one or more components whether or not the components are optical components. Those skilled in the art will recognize that other potential applications include, as examples, photonic devices, MEMS devices, high-precision microscopy, atomic-force microscopes, and high-precision laser-based medical devices.

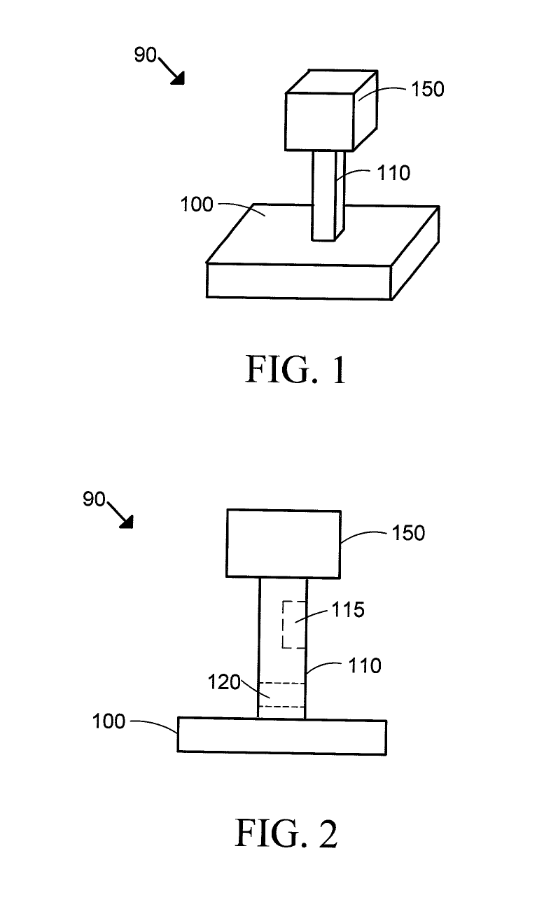

The present invention involves controlling changes in the material properties of a support structure to achieve precision positioning of components that may be supported by the support structure. For illustration, reference is now made to FIG. 1 wherein there is shown a perspective diagram of a millipede 90, an embodiment of the present invention for positioning a component such as a component used for optical applications. Millipede 90 includes a base 100 and a support structure 110. Preferably, support structure 110 is substantially rigid and is connected with and supported by based 100. In preferred embodiments, base 100 is substantially rigid. A first optical component 150 is shown connected with support structure 110. Of course, additional optical components can be included as part of the optical alignment. For example, a second optical component (not shown in FIG. 1) may be disposed so as to allow optical alignment between first optical component 150 and the second optical component.

Support structure 110 comprises one or more materials having properties that change in response to controlled process conditions so that application of the proper conditions causes support structure 110 to move the position of optical component 150 to a desired position, such as a position for substantially optimum optical coupling. Preferably, support structure 110 comprises one or more materials having material properties that change in response to applied energy or other process steps so as to cause support structure 110 to cause optical component 150 to attain different positions.

In one embodiment, the entire support structure 110 may be processed to produce desired dimension changes of the support structure. In alternative embodiments, one or more portions of support structure 110 may be processed to produce the desired dimension changes. To illustrate this point, reference is now made to FIG. 2 wherein there is shown a side view of millipede 90. Millipede 90 shown in FIG. 2 is substantially the same as that shown in FIG. 1. Millipede 90 includes base 100 and support structure 110. FIG. 2 indicates, using dashed lines, a portion 115 of support structure 110 and a portion 120 of support structure 110.

Inducing a dimension change in portion 115 can cause support structure 110 to bend as a result of expansion or contraction of portion 115. Specifically, for some embodiments of the present invention, if the density of portion 115 increases then portion 115 will contract. Analogously, if the density of portion 115 decreases, then portion 115 will expand. Bending support structure 110 will cause optical component 150 to attain a new position. The amount of bending of support 110 will depend upon how much of support structure 110 is included in portion 115. The amount of bending also depends on the material properties of support structure 110.

Portion 120 extends through substantially the entire width of support structure 110. Producing a dimension change in portion 120 can cause an increase or decrease in the length of support structure 110. For the arrangement as shown in FIG. 2, an increase or decrease in the length of support structure 120 would have the net result of moving optical component 150 nearer or further away from base 100.

Examples of the types of material property changes that can be used in practicing embodiments of the present invention include crystalline structure changes and atomic arrangement changes. Specifically, if a portion of support structure 110 is converted from a first crystalline phase to a second crystalline phase, having a different density so that a dimension of a portion of support structure 110 is modified, then support structure 110 will take on new dimensions in response to the dimension change of the portion, such as portion 115 and portion 120, of the support structure that was converted. For example, a change from body centered cubic structure to face centered cubic could produce this kind of result for some materials.

Additional examples of suitable material changes include a change in the crystal structure, a change in the ratio of crystalline to non-crystalline material, conversion to another material having different structural properties, a change in chemical composition, and a change in chemical composition profile. For instance, a change can be achieved by causing a change in the chemical composition of the structural element. The chemical composition change can result in a change in the dimensions of at least a portion of support structure 110, such as portion 115 and portion 120, as a result of changes in the density of the material. This dimension change causes the position changes of optical component 150.

Examples of methods that may be suitable for modifying the material of the support structure may include one or more steps such as changing the crystal structure, changing the ratio of crystalline to non-crystalline material, changing the chemical composition, changing the chemical composition profile, adding material, removing material, and changing the microstructure.

In some embodiments of the present invention, the composition change can be sufficient for producing a different material. As an example, a portion of or all of a support structure made of aluminum can be converted into aluminum oxide by the addition of oxygen to the support structure. The density of aluminum and the density of aluminum oxide are significantly different; converting a portion of or all of the support structure from one to the other would produce a dimension change for the support structure. Similarly, other material systems can also be used to produce dimension changes.

The term microstructure refers to the non-perfect structure of a crystalline material. Most solids consist of arrays of orderly arranged atoms or molecules to form well-defined lattice structures. However, lattice structures are not perfect and may contain vacancies, voids, interstitial shelf-atoms, interstitial impurities, dislocations, dislocation loops, and vacancy loops, to name but a few examples. The microstructure of a solid can be changed by mechanical, thermal, electromagnetic, or laser energy, which can result in a change in the dimension of the crystal lattice. Furthermore, most crystalline solids have slip-bands along which the crystal may slip and form a substantially permanent deformation.

Furthermore, microstructure-based changes in dimensions may be caused by phenomena such as a shift of adjacent crystal slip-planes, an increase in the dislocation network, an increase in the vacancy loop density, an increase in the surface fatigue slip-planes, and a pile-up of dislocations at a free surface or at a stress concentration point. Microstructure-base changes such as these can be used in practicing embodiments of the present invention.

Various types of energy can be applied to induce the change in the support structural. The usable types of energy will be dependent on the material properties of the support structure. Examples of suitable types of energy include mechanical energy, electrical energy, chemical energy, electromagnetic energy, and laser energy. For preferred embodiments of the present invention, laser energy is used to produce the changes in the structural element.

Some embodiments of the present invention include producing changes in the dimensions of the support structure using processes such as ion implantation, also referred to as ion-beam implantation. In some embodiments, the implantation of ions into interstitial sites of the support structure changes the dimensions of the lattice structure. Consequently, the lattice structure changes produce changes in the dimensions of the support structure. Ion implantation technology is well known and it is commonly used to implant predetermined amounts of a material into a substrate. The magnitude of the dimension changes can be controlled by factors such as adjusting the amount of material that is implanted and the selection of the implant material.

In still other embodiments of the present invention, dimension changes in the support structure can be produced by the addition of a dissimilar material to a surface area of the support structure. The addition of material can be achieved using deposition methods such as well know methods of chemical vapor deposition and physical vapor deposition. In this instance, dissimilar material refers to materials having one or more differing properties so that adding the dissimilar material to the support structure produces a dimension change. For instance, adding a material having a different internal stress to the surface of the support structure can produce dimension changes in the support structure by bending the structure.

Rather than adding material to the support structure to produce dimension changes, another embodiment of the present invention includes the step of removing material from the support structure to produce dimension changes. The removal can be achieved using processes such as chemical etching processes, ablation processes, and sputtering processes. In preferred embodiments, the removal of material is done so as to produce a stress induced dimension change of the support structure. In some embodiments, the support structure may comprise one or more dissimilar materials so that selective removal of one or more of the dissimilar materials causes the support structure to bend.

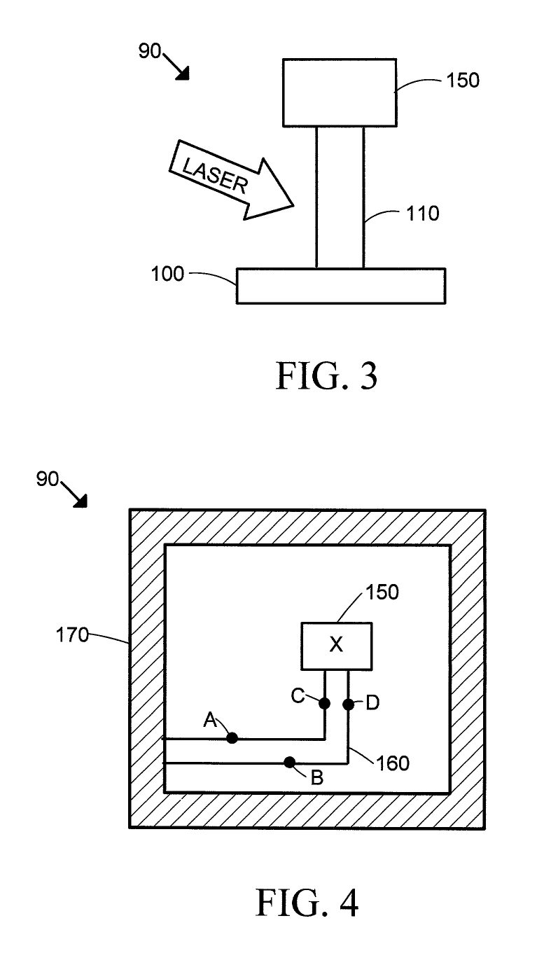

Reference is now made to FIG. 3 wherein there is shown a millipede 90 including base 100 and support structure 110 essentially the same as those described in FIG. 1 and FIG. 2. FIG. 3 shows an example of how a laser beam may be used to adjust support structure 110 in the millipede. Specifically, energy from the laser beam is applied at one or more locations on support structure 110 at a suitable power to produce changes in the position of a component 150 supported by support structure 110. The application of power from the laser causes changes in the material properties of support structure 110 that result in dimension changes as described for FIG. 2.

Embodiments of the present invention used for optical applications may allow light-coupling optimization so that it may be possible to achieve highly controllable motion with a precision ranging from about 1 nanometer to greater than about 1 micrometer, as a potential range. In addition, it is to be understood that support structure 110 may include multiple structural members that can be independently adjusted to produce the desired precision positioning of components.

Reference is now made to FIG. 4 wherein there is shown millipede 90 comprising support structure 160 and housing 170. Structure 160 is supported by housing 170. Housing 170 is cross-sectioned to show the interior. In preferred embodiments, housing 170 is capable of substantially containing or supporting one or more optical components, such as optical component 150. Support structure 160 has a shape that provides additional options for positioning component 150. Component 150 can be moved in x, y, and z directions as a result of applying laser energy at locations such as for example those indicated at A, B, C, and D in FIG. 4. Of course, other locations can also be used for applying laser energy.

FIG. 4 indicates that it is also possible to achieve larger ranges of motion by using combinations of pivot points and levers. Consequently, a small amount of motion can be multiplied by a lever effect. For instance, inducing support structure 160 to bend at locations such as location A or location B can be used to increase the magnitude of the movement of component 150, relative to using other points, or by changing the energy dose.

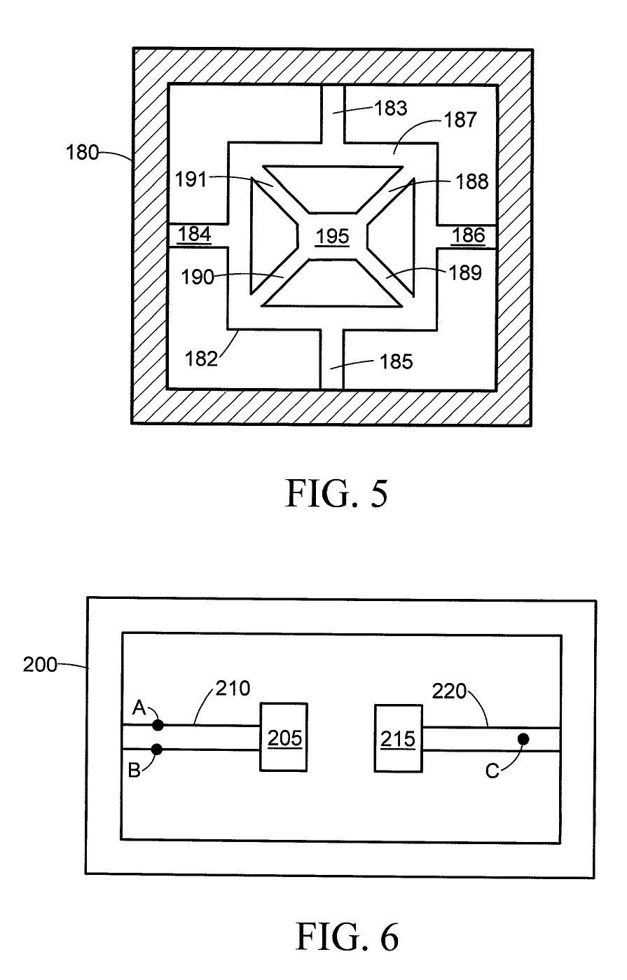

FIG. 5 shows an example of an example embodiment of a structure having multiple members for mounting an optical component. Specifically, FIG. 5 shows a base or housing 180 for support structure adjustable section 182. Adjustable section 182 includes members 183, 184, 185, 186, 187, 188, 189, 190, and 191 supporting platform 195. In this structure, the optical component may be mounted on platform 195. Application of laser energy at one or more locations on one or more structure members 183, 184, 185, 186, 188, 189, 190, and 191 can be used to manipulate the position of the optical component in any direction or rotation as appropriate for the desired optical coupling. In addition, structure member 187 may also be used for positioning by applying laser energy.

It is to be understood that this is only one example of possible structures that can be used; those skilled in the art will recognize that additional structure members or fewer structure members may be used and the arrangement of the structure members can be varied in different designs. Furthermore, it is to be understood that the structure members may be substantially co-planar in some embodiments, or the structure members may form non-co-planar three-dimensional structures.

For applications where a laser beam is used during processing of the support structure to achieve the desired positioning, examples of suitable materials for the support structure such as that shown in FIG. 5 include metals such as Si, Al, Mg, Cu, and metal alloys; oxides such as Al₂O₃, ZnO, ZrO, and SiO₂; nitrides such as Si3N4, AlN, TiN, and BN; composite materials such as metal-matrix composites and ceramic-matrix composites; and organic materials such as plastics, polyurethanes, and polymers. A variety of other materials may also be used in embodiments of the present invention that can allow achieving substantially the same results obtained using the example materials just listed.

The dimensions for a support structure such as that shown in FIG. 5 will depend upon the type of material used for the support structure, the types of components that are being positioned, and the type of processing equipment used for the position adjustments. Suitable combinations can be determined by those skilled in the art, in view of the present disclosure.

Reference is now made to FIG. 6 wherein there is shown a housing 200 having an open side, a first optical component 205, a first support structure 210, a second optical component 215, and a second support structure 220. Support structure 210 connects optical component 205 with housing 200. Support structure 220 connects optical component 215 with housing 200. Optical component 205 and optical component 215 are arranged so that application of sufficient laser energy to one or more locations on at least one of support structure 210 and support structure 220 allows positioning optical component 205 and optical component 215 so that they can be optically aligned.

For this type of arrangement, the method of achieving optical alignment includes the step of applying laser energy at sufficient powers and for sufficient time durations at locations on at least one of support structure 210 and support structure 220 so that the desired level of optical coupling is achieved. Examples of locations that may be suitable for applying laser power are indicated on the structural elements at locations indicated by A, B, and C in the FIG. 6.

In a preferred embodiment, the support structures 210 and 220 are manufactured so that they are part of housing 200 as a single unit. Clearly, it is also possible to have a similar arrangement using a base plate instead of housing 200.

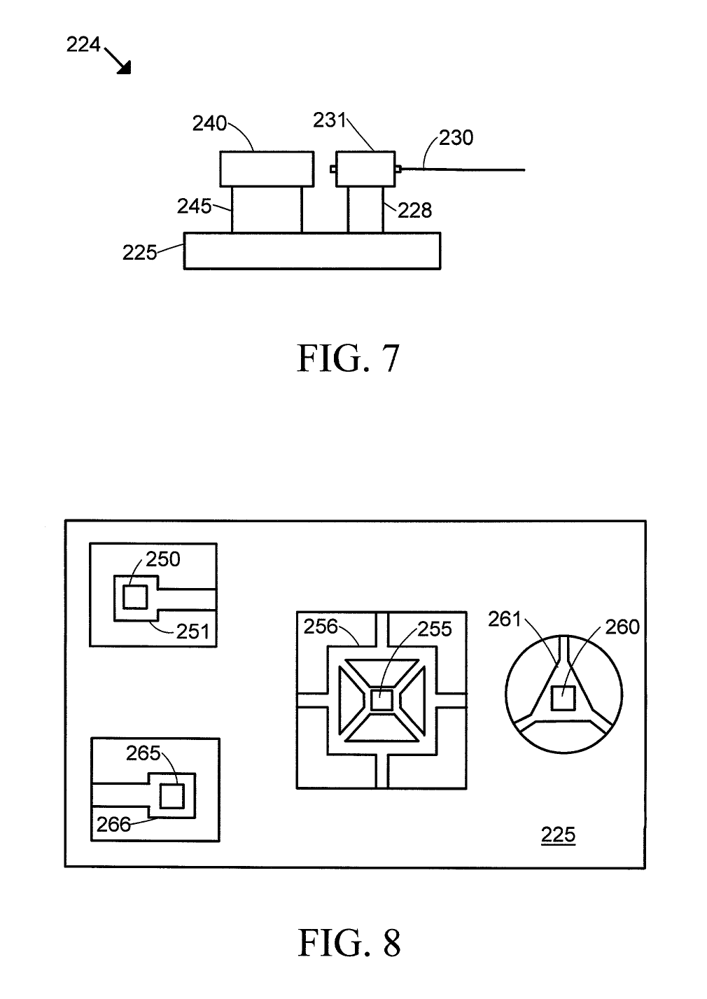

Reference is now made to FIG. 7 wherein there is shown a side view of an optical apparatus 224. Apparatus 224 includes a base plate 225, millipede 228, optical fiber 230, optical fiber holder 231 such as a ferrule, laser pump 240, and laser support 245. Millipede 228 is substantially the same as that described for FIG. 1 and FIG. 2 except that millipede 228 has been specifically configured to hold an optical fiber. Laser pump 240 is an optical component for providing an input of laser light to optical fiber 230. The position of optical fiber 230 can be adjusted with millipede 228 so as to optically align laser pump 240 with optical fiber 230. Optionally, laser support 245 may also be a millipede for adjusting the position of laser pump 240.

Reference is now made to FIG. 8 wherein there is shown a top view of an embodiment of the present invention that includes multiple optical component alignment. FIG. 8 shows optical components 250, 255, 260, and 265, and respectively associated millipedes 251, 256, 261, and 266. A base plate 225 is also shown. Millipede structures 251, 256, 261, and 266 are supported by base plate 225 and optical devices 250, 255, 260, and 265 are supported by millipede structures 251, 256, 261, and 266. Optionally, the millipede structures may be machined in the base plate and passively aligned prior to being actively aligned. Final alignment may be achieved by moving the millipede structures in desired directions by application of energy at one or more locations on the millipedes in sufficient amounts and for sufficient time duration so as to cause desired movement of optical components 250, 255, 260, and 265 so that they attain the desired optical alignment.

In a preferred embodiment, the millipede provides a platform on which a laser injection (pump) unit or other optical component is to be optically coupled to one or more other optical components. Examples of suitable optical components are optical fibers, mirrors, prisms, detectors, and other components such as those for optical communication applications. The laser injection unit is pre-mounted substantially permanently; the millipede is arranged so as to allow the platform to be altered in 6 axes of motion when one or more structures in the millipede is subjected to sufficient amounts of energy for sufficient durations of time. Examples of the types of energy include electrical, mechanical, electromagnetic, thermal, chemical, laser, and combinations of different types of energy. Once altered, the platform remains substantially fixed in reference to the optical fiber or other optical component. This design, of course, is not exclusive to laser pump and optical fiber components.

In a preferred embodiment, the light coupling optimization scheme utilizes a precision energy dosage to alter the support structure in the millipede. The energy dosage induces a local material and/or structural change at specific locations of the support structure to cause structure changes that result in the desired position shift for the optical component. Laser energy is one example of the type of energy that may be used in embodiments of the present invention for applying the energy dosage to the support structure. Some examples of suitable lasers include YAG lasers, Excimer lasers, and CO₂ lasers. In addition, other laser systems are commercially available.

In preferred embodiments, the millipedes may be designed and optimized for different axes of motion and different ranges of motion. These millipedes may be specifically designed for specific types of components. Examples of the types of optical components are lenses, prisms, ferrules, and other optical components such as those that are typically used in optical communication systems.

An embodiment of the fabrication process may include having the optical components mounted onto millipedes and then the millipedes with the optical components are mounted in a standard optical package using conventional fabrication methods. Next, these packages may be processed using a correction system, such as a laser correction apparatus that provides doses of laser energy, to fine-tune the alignment to achieve substantially optimum light coupling. Specifically, the laser system is used to apply energy to locations on the support structure of the millipedes to cause the components to move into positions of optical alignment.

An advantage of embodiments of the present invention is that components mounted on the millipedes can be moved in any direction in very fine increments. Such levels of control may be difficult or impossible for conventional alignment techniques. Another advantage of embodiments of the present invention is that the movement induced in the millipede is a substantially permanent change so that no additional bonding or soldering is required to hold the final position. Consequently, it is expected that embodiments of the present invention may allow the elimination of one or more of the traditional fabrication steps for optical packages.

Another embodiment of the present invention includes optoelectronic devices and optoelectronic packages that use substantially no epoxy in the light path. Eliminating epoxy in this way has the potential of extending the reliability and lifetime of the optical packages. The degradation of properties of epoxy in optical applications has been a long-term problem.

While there have been described and illustrated specific embodiments of the invention, it will be clear that variations in the details of the embodiments specifically illustrated and described may be made without departing from the true spirit and scope of the invention as defined in the appended claims and their legal equivalents.

What is claimed is:

1. A method of positioning components on a support structure comprising the step of causing position changes by modifying at least a portion of the material of the support structure by inducing at least one of:
a density change and
an internal stress change.

2. The method of claim 1 wherein the density change is the result of at least one of:
a change in the crystal structure;
a change in the ratio of crystalline to non-crystalline material;
a change in chemical composition;
a change in chemical composition profile; and
a change in microstructure.

3. The method of claim 1 wherein the internal stress change is the result of at least one of:
a change in the crystal structure;
a change in the ratio of crystalline to non-crystalline material;
a change in chemical composition;
a change in chemical composition profile;
addition of material;
removal of material; and
a change in microstructure.

4. The method of claim 1 wherein modifying at least a portion of the material comprises application of an amount of energy.

5. The method of claim 4 wherein the energy comprises at least one of mechanical energy, electrical energy, chemical energy, electromagnetic energy, and laser energy.

6. The method of claim 4 wherein the amount of energy comprises at least one pulse of laser energy.

7. The method of claim 4 wherein the material of the support structure comprises at least one of metal, metal alloy, ceramic, polymer, and composite material.

8. The method of claim 1 wherein the internal stress change results from at least one of an addition of a dissimilar material to a surface of the support structure, an ion implantation of the support structure with an amount of a material.

9. The method of claim 1 wherein the support structure comprises at least two dissimilar materials and the internal stress change results from the removal of an amount of at least one of the dissimilar materials.

10. A method of alignment and assembly of optical components, at least one of the optical components having an associated support structure, the method comprising the steps of:
a) monitoring the optical coupling efficiency for the optical components;
b) causing position changes of the at least one optical component in response to the coupling efficiency by modifying at least a portion of the material of the support structure by inducing at least one of density change, internal stress, and microstructure change to move the at least one optical component so as to achieve a substantially optimum optical coupling efficiency.

11. The method of claim 10 wherein the density change is the result of at least one of:
a change in the crystal structure;
a change in the ratio of crystalline to non-crystalline material;
a change in chemical composition; and
a change in chemical composition profile and
a change in microstructure.

12. The method of claim 10 wherein the internal stress change is the result of at least one of:
a change in the crystal structure;
a change in the ratio of crystalline to non-crystalline material;
a change in chemical composition;
a change in chemical composition profile;
addition of material; and
removal of material and
a change in microstructure.

13. An optoelectronic package comprising:
at least two optical components; and
at least one support structure;
one of the optical components being supported by the support structure wherein the optical alignment of the optical components has been effected through changes in a dimension of the support structure by modifying at least a portion of the material of the support structure by inducing at least one of:
a density change,
an internal stress change, and
a microstructure change.

14. The device of claim 13 wherein the dimension change results from at least one of:
an application of an amount of energy to the support structure and
an ion implantation of the support structure with an amount of a material.

15. The device of claim 13 wherein the dimension change results from the application of at least one chemical element to the support structure.

16. A method of positioning components on a support structure comprising the step of causing position changes by modifying the density of at least a portion of the material of the support structure.

17. The method of claim 16 wherein modifying the density comprises inducing a change in crystalline phase.

18. The method of claim 16 wherein modifying the density comprises inducing a change in chemical composition.

19. The method of claim 16 wherein modifying the density comprises inducing a change in microstructure.

20. The method of claim 17 wherein inducing the change in crystalline phase comprises application of an amount of energy to the support structure.

21. An optical package for use in producing an optically aligned optical package comprising:
at least two optical components; and
at least one support structure;
one of the optical components being supported by the support structure, the support structure comprising a material capable of undergoing crystalline phase changes that cause position changes for the optical component supported by the support structure.

22. The optical package of claim 21 wherein the support structure material comprises at least one of metal, metal alloy, ceramic, polymer, and composite material.

23. The optical package of claim 21 wherein the support structure material is capable of undergoing phase changes in response to the application of energy.

24. An optical apparatus comprising:
at least two optical components; and
at least one support structure;
one of the optical components being supported by the support structure, at least a portion of the support structure having an induced density variation for optical alignment of the optical components.

25. An optical package comprising: at least one optical component and means for positioning the at least one optical component.

26. A system for aligning optical components comprising:
means for monitoring the optical coupling efficiency for the optical components; and
means for changing the relative position of at least one optical component with respect to a least one other optical component in response to the monitored coupling efficiency.

27. A method of positioning optical components on a support structure comprising the step of causing position changes by inducing a dimension change in at least a portion of the material of the support structure.

28. The method of claim 27 wherein the dimension change is the result of at least one of:
a change in the crystal structure;
a change in the ratio of crystalline to non-crystalline material;
a change in density;
a change in chemical composition;
a change in chemical composition profile; and
a change in microstructure.

29. The method of claim 27 wherein inducing the dimension change comprises application of an amount of energy.

30. The method of claim 29 wherein the energy comprises at least one of mechanical energy, electrical energy, chemical energy, electromagnetic energy, and laser energy.

31. The method of claim 29 wherein the amount of energy comprises at least one pulse of laser energy.

32. The method of claim 29 wherein the material of the support structure comprises at least one of metal, metal alloy, ceramic, polymer, and composite material.

33. A method of alignment and assembly of optical components, at least one of the optical components having an associated support structure, the method comprising the steps of:
a) monitoring the optical coupling efficiency for the optical components;
b) causing position changes of the at least one optical component in response to the coupling efficiency by inducing a dimension change in at least a portion of the material of the support structure by creating at least one of a change in crystal structure, a change in the ratio of crystalline to non-crystalline material, a change in density, a change in chemical composition, a change in microstructure, and a change in chemical composition profile to move the at least one optical component so as to achieve a substantially optimum optical coupling efficiency.

34. An optoelectronic device comprising:
at least two optical components; and
at least one support structure;
one of the optical components being supported by the support structure wherein the optical alignment of the optical components has been effected through changes in a dimension of the support structure by modifying at least a portion of the material of the support structure by inducing at least one of a phase change and a microstructure change.

35. The device of claim 34 wherein the phase change results from the application of an amount of energy to the support structure.

36. The device of claim 34 wherein the changes in the dimensions of the support structure results from the application of at least one chemical element to the support structure.
